(19) United States
(12) Patent Application Publication
(10) Pub. No.: US 2009/0058787 A1
(43) Pub. Date: Mar. 5, 2009

(54) Image Display System, A Liquid Crystal Display Device, And A Discharge Circuit Of The Liquid Crystal Display Device

(76) Inventors: Chih-Hsun WENG, ChuNan (TW); Sheng-Feng Huang, ChuNan (TW)

Correspondence Address: VENABLE, Post Office Box 34385, Washington, DC, 20043-9998, US

(21) Appl. No.: 12/201,878

(22) Filed: Aug. 29, 2008

(30) Foreign Application Priority Data
Aug. 31, 2007 (TW) 96132468

(51) Int. Cl. G09G 3/36

(52) U.S. Cl. 345/98

(57) ABSTRACT

The present invention relates to a discharge circuit of a liquid crystal display device which receives a power and controls the charges stored in the pixel units of the pixel matrix of the liquid crystal display device. The discharge circuit includes a control circuit receiving the power and generating a control signal when being disconnected from the power, a horizontal driver and a pre-charge circuit forming a plurality of discharge paths having switches, and a selection circuit receiving the control signal and generating a selection signal for enabling the switches of the discharge paths.

### BACKGROUND OF THE INVENTION

1. Field of the Invention

The present invention relates to an image display system, a liquid crystal display device, and a discharge circuit of the liquid crystal display device. In particular, the present invention relates to an image display system, a liquid crystal display device, and a discharge circuit of the liquid crystal display device capable of discharging in the event of an abnormal shutdown.

2. Description of the Related Art

Normally, following standard procedures, the liquid crystal display device of an image display system can be shut down properly by virtue of an application-for-specific integrated circuit (ASIC), which is built in the system and controls the shutdown procedure to ensure that the image-displaying pixel matrix is properly discharged.

However, if the liquid crystal display device is shut down abnormally, causing the control circuit to experience a sudden disconnection of power without receiving a command signal, the control circuit and the logic gate of the liquid crystal display device may hence become unable to exercise their control functions. As long as the control circuit is unable to control the shutdown procedure of the liquid crystal display device, the image will not be completely closed down after the liquid crystal display device is shut down, resulting in the image retention of the display device.

Conventional liquid crystal display devices, especially the small ones, are always equipped with a discharge circuit within the system thereof, so as to allow the pixel matrix of the liquid crystal display device to instantly discharge at the time the liquid crystal display device is abnormally shut down.

FIG. 6 schematically shows the configuration of a conventional liquid crystal display device and the electronic system connected thereto, i.e. a liquid crystal display device 10 and an external electronic system 20 controlling the liquid crystal display device 10. The external electronic system 20 further includes a processor 21, an application circuit 22, a system circuit 23, and a discharge circuit 24. The processor 21 of the external electronic system 20 provides different control signals, depending upon the command signals from the application circuit 22 and the system circuit 23, to the liquid crystal display device 10, so as to control the image display of the liquid crystal display device 10. By way of the discharge circuit 24, the external electronic system 20 enables the liquid crystal display device 10 to discharge in the event of an abnormal shutdown, so as to avoid the image retention in the liquid crystal display device 10.

FIG. 7 is a schematic view of a logic circuit of the discharge circuit 24 in the conventional electronic system. As shown in FIG. 7, a voltage signal VDD is a positive voltage supplying for both the discharge circuit 24 and the liquid crystal display device 10, whereas the voltage signal VEE is a negative voltage supplying for the gate of the internal circuit of the liquid crystal display device 10. In case of normal circumstances, the transistor (PMOSFET) Q1 is switched off, allowing the capacitor C2 to store a voltage of VDD−V_{D1}=V_{C2}, derived from the voltage signal VDD. However, when the liquid crystal display device 10 is disconnected from the power, the voltage signal VDD would be set to a low voltage level such that VDD may be less than V_{C2}, and the transistor Q1 is thus switched on, enabling the charge sharing between the capacitor C2 and the capacitor C1. The voltage level of capacitor C1 will be set to a high level upon receiving the electric charges from capacitor C2, and thus the voltage level of the voltage signal VEE would be increased to a high voltage level, so as to switch on the gate inside the liquid crystal display device 10 and to enable the charges stored inside the liquid crystal display device 10 to be released. In this case, the image retention is avoided.

Although the circuit design described above helps prevent the image retention, the requirement to install an additional discharge circuit in the electronic system still remains subject the system designer to high costs and complicated designs.

### SUMMARY OF THE INVENTION

It is an aspect of the present invention to provide a liquid crystal display device and a discharge circuit thereof. By the provided discharge circuit of the liquid crystal display device, the liquid crystal display device is provided with a discharge path for releasing the charges stored the liquid crystal capacitor (C_{L}) of the internal pixel unit even when the liquid crystal display device is abnormally shut down.

In accordance with the mentioned aspect, the present invention provides a discharge circuit of a liquid crystal display device having a plurality of pixel units of a pixel matrix. The discharge circuit receives a power and controls charges stored in the pixel units, which includes a control circuit receiving the power and generating a control signal when being disconnected from the power, a horizontal driver and a pre-charge circuit forming plural discharge paths having switches, and a selection circuit receiving the control signal and generating a selection signal enabling the switches of the discharge paths.

In accordance with the mentioned aspect, the present invention also provides a liquid crystal display device including a pixel matrix having a plurality of pixel units, a control circuit controlling the charges stored in the pixel units, receiving a power, and generating a control signal when being disconnected from the power, a horizontal driver and a pre-charge circuit forming a plurality of discharge paths having switches, and a selection circuit receiving the control signal and generating a selection signal enabling the switches of the discharge paths.

In accordance with the mentioned aspect, the present invention further provides an image display system including a liquid crystal display device as mentioned and a power supply coupled to the liquid crystal display device and supplying power to the liquid crystal display device.

The provided discharge circuit of the liquid crystal display device is built inside the liquid crystal display device rather than provided by an external electronic system. In this case, the liquid crystal display device provided with a discharge path to discharge even the device is abnormally shut down.

The aspects or the features of the present invention are exemplified in detail by the attached figures. However, examples given by the figures serve for explanatory purposes only and should not be construed as a limitation on the actual applicable scope of the invention.

### BRIEF DESCRIPTION OF THE DRAWINGS

FIG. 1 schematically shows the configuration of a liquid crystal display device according to one embodiment of the present invention.

FIG. 2A schematically shows the structure of a pixel matrix according to one embodiment of the present invention.

FIG. 2B schematically shows a pixel unit of the pixel matrix according to one embodiment of the present invention.

FIG. 3 is a schematic view of a logic circuit of the vertical driver according to one embodiment of the present invention.

FIG. 4 is a schematic view of a logic circuit of the pre-charge circuit according to one embodiment of the present invention.

FIG. 5 schematically shows the configuration of a liquid crystal display device according to another embodiment of the present invention.

FIG. 6 schematically shows the configuration of a conventional liquid crystal display device and the electronic system connected thereto in accordance with the prior art.

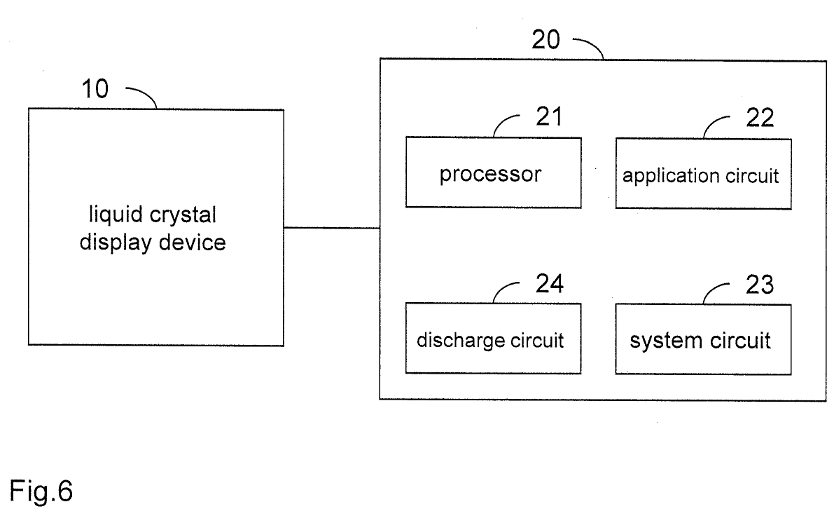

FIG. 7 is a schematic view of a logic circuit of the discharge circuit in the conventional electronic system.

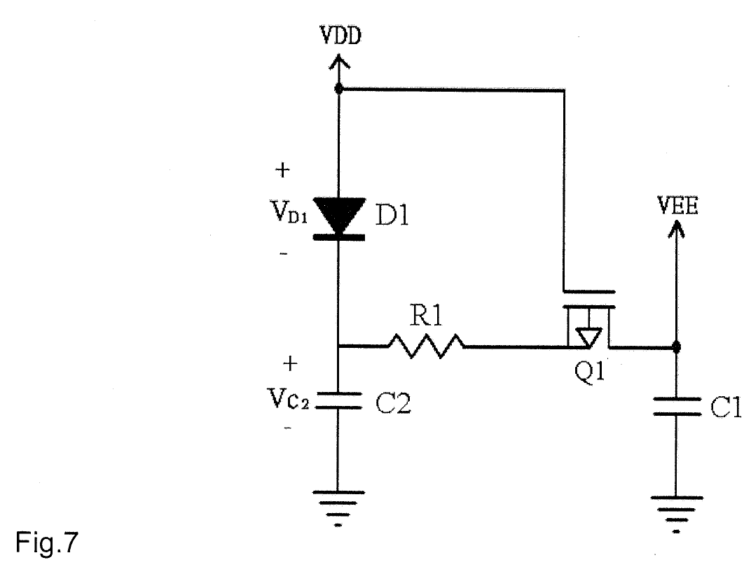

FIG. 8 schematically shows the configuration of an image display system according to another embodiment of the present invention.

### DETAILED DESCRIPTION OF THE PREFERRED EMBODIMENTS

The examples given below serve as the preferred embodiments of the present invention only. The examples should not be construed as a limitation on the actual applicable scope of the invention, and as such, all modifications and alterations without departing from the spirits of the invention and appended claims, including other embodiments, shall remain within the protected scope and claims of the invention.

The present invention relates to a liquid crystal display device, especially a liquid crystal display device having a discharge circuit capable of releasing charges in the event of an abnormal shutdown.

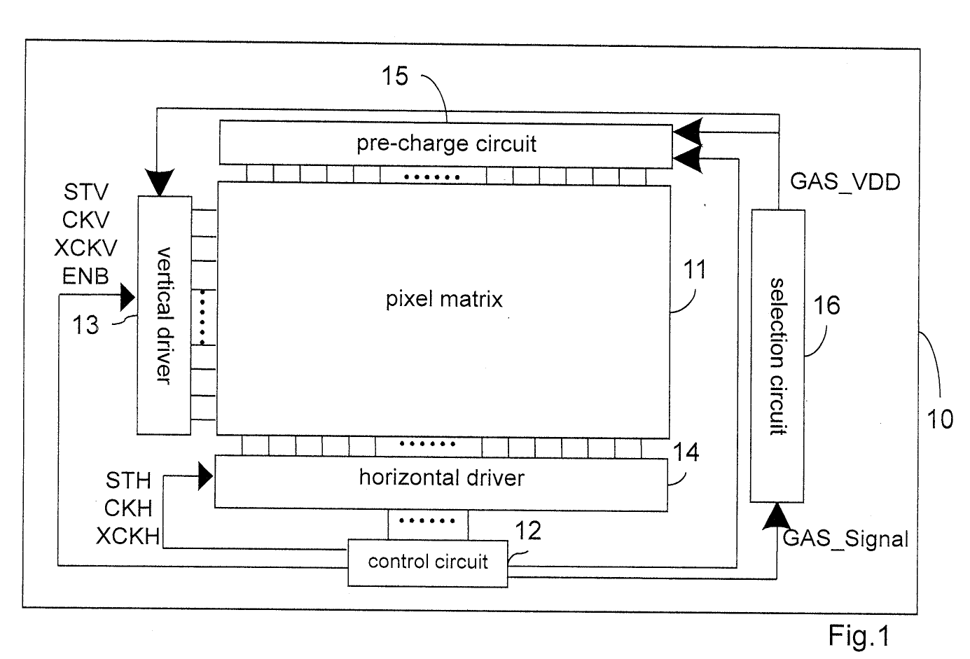

FIG. 1 schematically shows the configuration of a liquid crystal display device according to one embodiment of the present invention. In this embodiment, the liquid crystal display device 10 is mainly constructed by a pixel matrix 1, an application for specific integrated circuit (ASIC) serving as a control circuit 12, a vertical driver 13, a horizontal driver 14, a pre-charge circuit 15, and a gate-all-selection (GAS) circuit serving as a selection circuit 16.

The control circuit 12 is connected to both the vertical driver 13 and the horizontal driver 14, so as to transmit the control signals STV, CKV, XCKV, and ENB to the vertical driver 13 and to transmit the control signals STH, CKH, and XCKH to the horizontal driver 14, respectively, to control the image display of the pixel matrix 11. The control circuit 12 is also connected to the selection circuit 16 to control the pre-charge circuit 15, so as to allow the pixel matrix 11 to discharge.

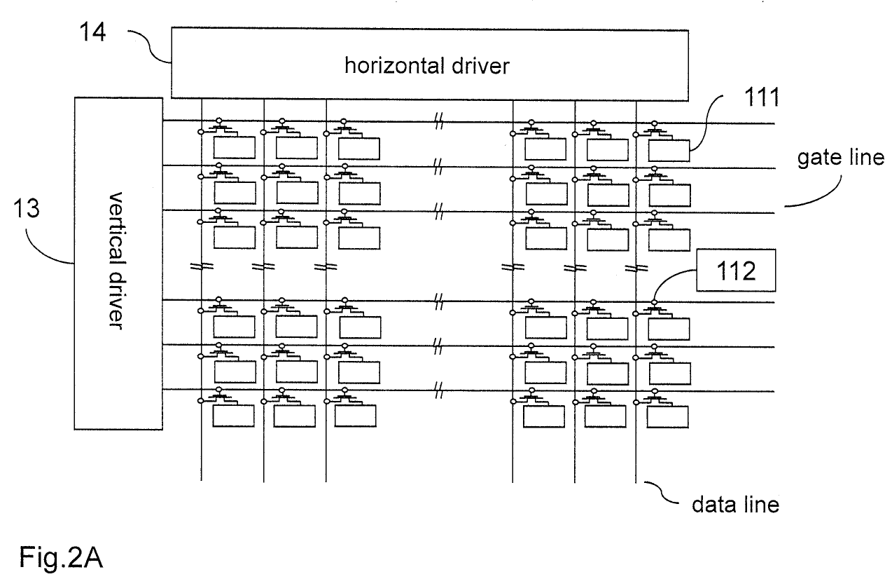

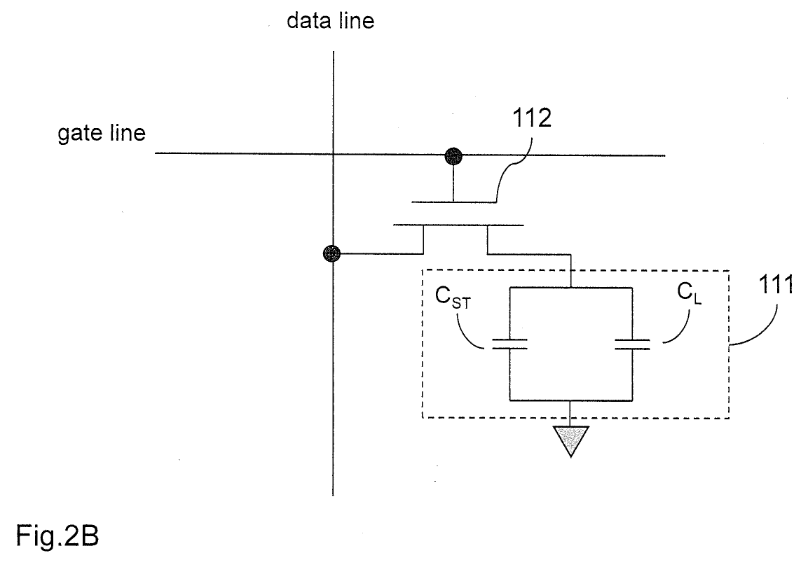

FIG. 2A schematically shows the structure of a pixel matrix according to one embodiment of the present invention. The pixel matrix 11 includes plural pixel units 111 and plural pixel switches 112, wherein the pixel units 111 contain charges stored therein so as to display images with various effects, whereas the pixel switches 112 are serving as electrical switches. According to various embodiments of the present invention, the pixel switch 112 can be a thin film transistor (TFT).

The horizontal driver 14 controls the charges stored in the pixel units 111 via a plurality of data lines, whereas the vertical driver 13 controls the on and off of the pixel switches 112 via a plurality of gate lines. All of the pixel switches 112 connected to a gate line will be switched on when the vertical driver 13 supplies a high level voltage signal to the gate line, enabling the pixel units 111 corresponding to the pixel switches 112 to be directly connected to the data line. On the other hand, all of the pixel switches 112 connected to a gate line will be switched off when the vertical driver 13 supplies a low level voltage signal to the gate line, enabling the pixel units 111 corresponding to the pixel switches 112 to be disconnected from the data line.

FIG. 2B schematically shows a pixel unit of the pixel matrix according to one embodiment of the present invention. As shown in FIG. 2B, each of the pixel units 111 includes a liquid crystal capacitor C_{L} and a storage capacitor C_{ST} connected in parallel for holding the characteristics of the liquid crystal capacitor C_{L} When one pixel switch 112 is switched on, the liquid crystal capacitor C_{L} is charged/discharged by the horizontal driver 14 via the corresponding data line, so as to make changes to the charges stored in the liquid crystal capacitor C_{L} to adjust the image display effect of the pixel unit 111.

Referring to FIG. 1 and FIG. 2A, when the liquid crystal display device 10 is abnormally shut down, the control circuit 12 may suffer a sudden loss of power, and fail to transmit the control signals STV, CKV, and XCKV to the vertical driver 13 effectively and fail to transmit the control signals STH, CKH, and XCKH to the horizontal driver 14. Under such circumstances, the pixel matrix 11 is unable to be timely switched off by the control circuit 12, which means the charges stored in the liquid crystal capacitors C_{L} of parts of the pixel units 111 cannot be released in time. At this point, through the control of the selection circuit 16, the charges stored in the liquid crystal capacitors C_{L} can be released by the pre-charge circuit 15, so as to avoid the image retention in the pixel matrix 11.

In one embodiment of the present invention, once an abnormal shutdown, i.e., a shutdown without a command signal, is detected, the control circuit 12 may capitalize on the remaining power to generate a low-energy control signal (GAS_Signal) and send such control signal (GAS_Signal) to the selection circuit 16, so as to enable the selection circuit 16 to generate a selection signal (GAS_VDD) with the received control signal (GAS_Signal) and to send such selection signal (GAS_VDD) to the vertical driver 13 and the pre-charge circuit 15.

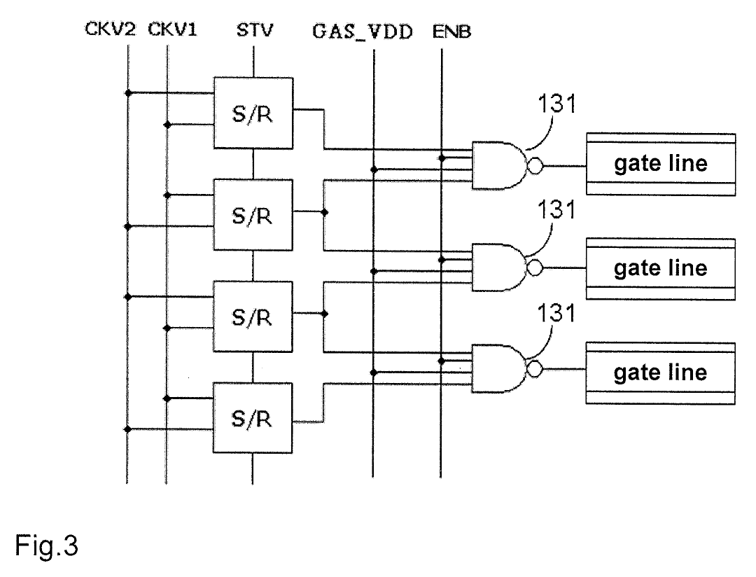

Referring to FIG. 1 and FIG. 3, where FIG. 3 is a schematic view of a logic circuit of the vertical driver 13 according to one embodiment of the present invention, the selection circuit 16 provides the selection signal (GAS_VDD) to the vertical driver 13, so as to control the voltage level of the gate line. To be specific, the vertical driver 13 includes a plurality of NAND gates 131 for controlling the gate line to supply either high-level voltage signals or low-level voltage signals. When the control circuit 12 receives a reliable power, the selection circuit 16 may generate a selection signal (GAS_VDD) of high level, and thus the control signals CKV1, CKV2, and STV and ENB for the operation on the plurality of NAND gates 131 are not affected.

The voltage level of the selection signal (GAS_VDD) would be set to low when an abnormal shutdown is detected by the control circuit 12, causing the NAND gates 131 to produce a high-level voltage signal, and further enabling all pixel switches 112 to be switched on. As a result, all of the data lines are connected to the liquid crystal capacitors C_{L} corresponding thereto, so as to allow the pre-charge circuit 15 to control the charge/discharge of the liquid crystal capacitors C_{L}.

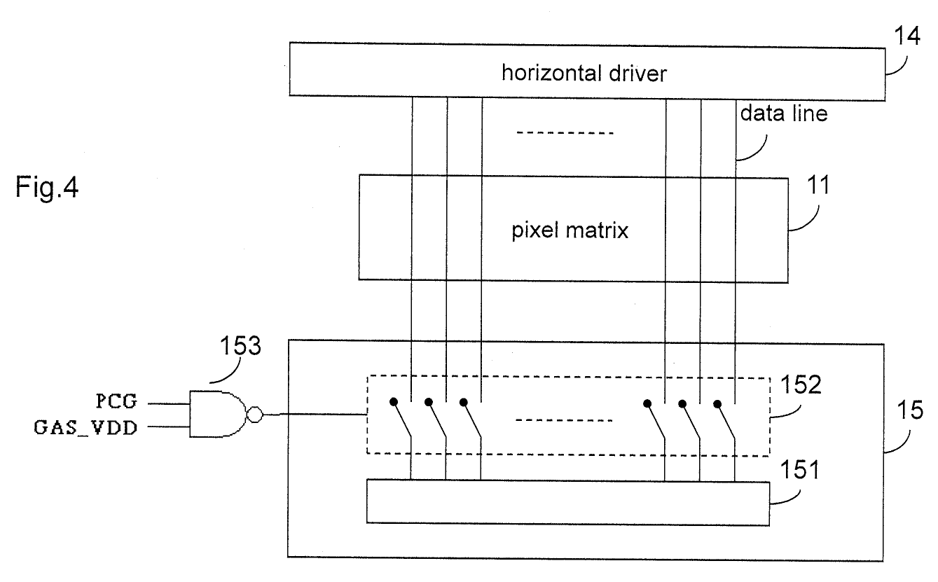

FIG. 4 is a schematic view of a logic circuit of the pre-charge circuit 15 according to one embodiment of the present invention. As shown in FIG. 4, the pixel matrix 11 is controlled by the horizontal driver 14 through the data lines. In addition, the horizontal driver 14 forms a discharge path along with the pre-charge circuit 15, such that the pixel unit 111 of the pixel matrix 11 can release the charges by way of the pre-charge circuit 15.

The pre-charge circuit 15 further includes a pre-charge data circuit (PCD circuit) 151 and a plurality of selection switches 152. The PCD circuit 151 supplies a pre-charge data (PCD) to serve as the initial display signal of the pixel matrix 11. When the PCD is sent to a data line through the PCD circuit 151, the pixel unit 111 connected to the data line would be reset, so as to release the charges stored in the liquid crystal capacitors C_{L} of all pixel units 111 connected to the data line by way of the PCD circuit 151. The selection switches 152 are used to connect the horizontal driver 14 to the PCD circuit 151 through the data line, so as to form a discharge path, allowing the liquid crystal capacitor C_{L} of the pixel unit 111 to release the charges by way of the PCD circuit 151.

The selection signal (GAS_VDD) is coupled with a pre-charge control signal (PCG) through a NAND gate at the input end of the pre-charge circuit 15. The PCG is used to control the on and off of the selection switch of the pre-charge circuit 15. However, when the liquid crystal display device 10 is abnormally shut down, the control circuit 12 may fail to generate a PCG having sufficient energy to control the selection switches. As a result, the PCG becomes a control signal indicating the failure of control function.

The voltage level of the selection signal (GAS_VDD) is set to the low level when the liquid crystal display device 10 is abnormally shut down. Therefore, the low-level selection signal (GAS_VDD) may be converted to a high-level voltage signal by way of the NAND gate 153, which enables the selection switches 152 to be switched on. As a result, the liquid crystal capacitors C_{L} of all pixel units 111 are able to release the stored charges by way of the PCD circuit 151.

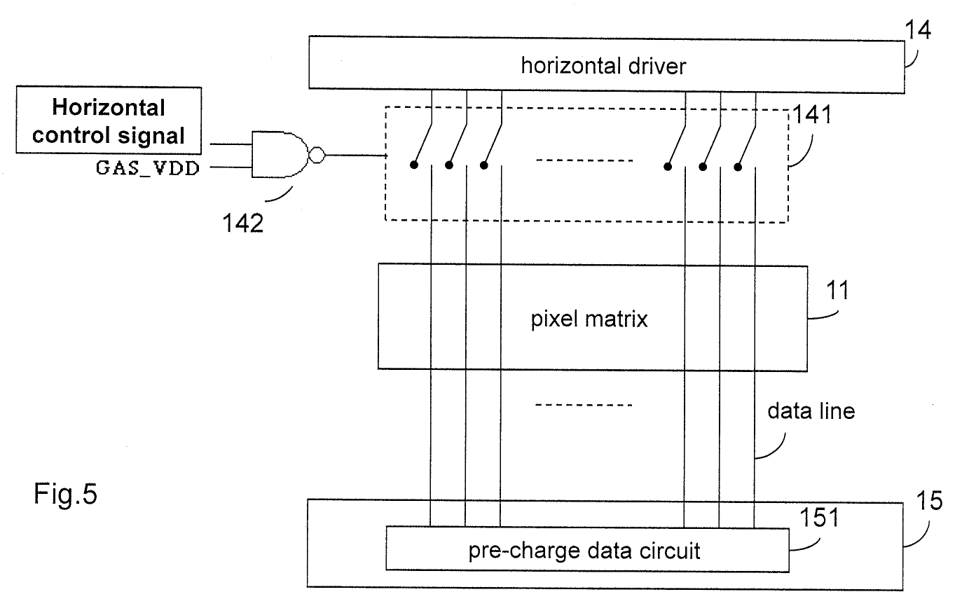

FIG. 5 schematically shows the configuration of a liquid crystal display device according to another embodiment of the present invention. In this embodiment, a plurality of selection switches 141 are configured in the horizontal driver 14, so as to form a discharge path. The discharge path allows the liquid crystal capacitors C_{L} of the pixel units 111 to release the stored charges by way of the horizontal driver 14. When the liquid crystal display device 10 is abnormally shut down, the selection signal (GAS_VDD) is directly sent to the selection switch of the horizontal driver 14, causing the voltage level of the selection signal (GAS_VDD) to be set to the low level, and thus converting the low-level selection signal (GAS_VDD) to a high-level voltage signal through the connected NAND gate 142. The selection switches are switched on with the high-level voltage signal, allowing the liquid crystal capacitors C_{L} of all pixel units 111 to release the stored charges by way of the horizontal driver 14.

In views of the mentioned, the voltage level of all the gate lines is increased to a high level by the vertical driver 13 once the selection signal (GAS_VDD) is received. In addition, because all pixel switches 112 are switched on, the liquid crystal capacitors C_{L} of all pixel units 111 may be connected to the respective data lines corresponding thereto. Moreover, once the selection signal (GAS_VDD) is received by the pre-charge circuit 15, the liquid crystal capacitors C_{L} of all pixel units 111 may be reset by the PCD circuit 151 in the pre-charge circuit 15 through the data lines, so as to prevent image retention in the pixel matrix 11 in the event of an abnormal shutdown.

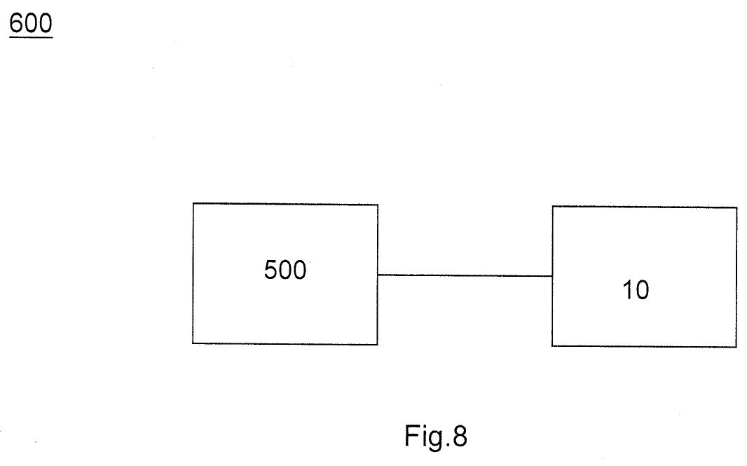

FIG. 8 schematically shows the configuration of an image display system according to another embodiment of the present invention. In this embodiment, the image display system 600 includes a liquid crystal display device 10 and a power supply 500. The power supply 500 is coupled to the liquid crystal display device 10 so as to provide electric energy to the liquid crystal display device 10. The image display system 600 may be one selected from a group consisting of a cell phone, a digital camera, a personal digital assistant (PDA), a laptop computer, a desktop computer, a television, a global positioning system (GPS), a vehicle display, an avionics display, a digital photo frame, and a portable DVD player.

In the present invention, by the provided liquid crystal display device and the discharge circuit thereof, the system designer is no longer required to design a discharge circuit in an external electronic system to enable the liquid crystal display device to release the charges in the event of an abnormal shutdown. As a result, the image retention in the liquid crystal display device can be avoided.

The examples given above serve as the preferred embodiments of the present invention only. The examples should not be construed as a limitation on the actual applicable scope of the invention, and as such, all modifications and alterations without departing from the spirits of the invention and appended claims, including other embodiments, shall remain within the protected scope and claims of the invention.

What is claimed is:

1. A discharge circuit of a liquid crystal display device having a plurality of pixel units of a pixel matrix, the discharge circuit receiving a power and controlling charges stored in the pixel units, comprising:
a control circuit receiving the power and generating a control signal when being disconnected from the power;
a horizontal driver and a pre-charge circuit forming a plurality of discharge paths having switches; and
a selection circuit receiving the control signal and generating a selection signal enabling a switch of the discharge paths.

2. The discharge circuit of as claimed in claim 1, wherein the selection signal is set to a low voltage level when the control circuit is disconnected from the power.

3. The discharge circuit of as claimed in claim 2, wherein the switch of the discharge path is switched on when the selection signal is set to the low voltage level.

4. The discharge circuit of as claimed in claim 1, wherein the switch of the discharge path is configured in the horizontal driver and the selection signal is transmitted to the horizontal driver to enable the switch to be switched on.

5. The discharge circuit of as claimed in claim 1, wherein the pre-charge circuit further comprises a pre-charge data circuit (PCD circuit), and wherein the switch of the discharge path is configured in the PCD circuit and the selection signal is transmitted to the pre-charge circuit to enable the switch to be switched on.

6. The discharge circuit of as claimed in claim 1, wherein the pixel matrix further comprises a plurality of switches for enabling the pixel units to be connected to the discharge paths.

7. The discharge circuit of as claimed in claim 6, further comprising a vertical driver for controlling the switches of the pixel matrix.

8. The discharge circuit of as claimed in claim 7, wherein the selection signal is coupled to an output end of the vertical driver through an NAND gate.

9. The discharge circuit of as claimed in claim 6, wherein the selection signal is set to a low voltage level when the control circuit is disconnected from the power, so as to enable the switches of the pixel matrix to be switched on.

10. A liquid crystal display device, comprising:
a pixel matrix having a plurality of pixel units;
a control circuit controlling charges stored in the pixel units, receiving a power, and generating a control signal when being disconnected from the power;
a horizontal driver and a pre-charge circuit forming a plurality of discharge paths having switches; and
a selection circuit receiving the control signal and generating a selection signal for enabling a switch of the discharge paths.

11. The liquid crystal display device as claimed in claim 10, wherein the selection signal is set to a low voltage level when the control circuit is disconnected from power.

12. The liquid crystal display device as claimed in claim 11, wherein the switch of the discharge path is switched on when the selection signal is set to the low voltage level.

13. The liquid crystal display device as claimed in claim 10, wherein the switch of the discharge path is configured in the horizontal driver and the selection signal is transmitted to the horizontal driver to enable the switch to be switched on.

14. The liquid crystal display device as claimed in claim 10, wherein the pre-charge circuit further comprises a pre-charge data circuit (PCD circuit), and wherein the switch of the discharge path is configured in the PCD circuit and the selection signal is transmitted to the pre-charge circuit to enable the switch to be switched on.

15. The liquid crystal display device as claimed in claim 10, wherein the pixel matrix further comprises a plurality of switches enabling the pixel units to be connected to the discharge paths.

16. The liquid crystal display device as claimed in claim 15, further comprising a vertical driver for controlling the switches of the pixel matrix.

17. The liquid crystal display device as claimed in claim 16, wherein the selection signal is coupled to an output end of the vertical driver through an NAND gate.

18. The liquid crystal display device as claimed in claim 15, wherein the selection signal is set to a low voltage level when the control circuit is disconnected from the power, so as to enable the switches of the pixel matrix to be switched on.

19. An image display system, comprising:
a liquid crystal display device as claimed in claim 10; and
a power supply coupled to the liquid crystal display device and supplying power to the liquid crystal display device.

20. The image display system as claimed in claim 19, wherein the image display system is selected from a group consisting of a cell phone, a digital camera, a personal digital assistant (PDA), a laptop computer, a desktop computer, a television, a global positioning system (GPS), a vehicle display, an avionics display, a digital photo frame, and a portable DVD player.
